(19) United States
(12) Patent Application Publication
(10) Pub. No.: US 2025/0163987 A1
(43) Pub. Date: May 22, 2025

(54) DAMPING FORCE VARIABLE VALVE ASSEMBLY AND SHOCK ABSORBER

(71) Applicant: HL Mando Corporation, Pyeongtaek-si (KR)

(72) Inventors: Jongsun LEE, Pyeongtaek-si (KR); Wonbeen IM, Pyeongtaek-si (KR)

(21) Appl. No.: 18/440,732

(22) Filed: Feb. 13, 2024

(30) Foreign Application Priority Data
Nov. 16, 2023 (KR) 10-2023-0159043

(51) Int. Cl. F16F 9/342

(52) U.S. Cl. CPC F16F 9/342

(57) ABSTRACT

In an outer housing and a damping force adjustment unit constituting a damping force variable valve assembly and a damping force variable shock absorber of the present disclosure, a main flow path through which fluid flows during compression and extension strokes, a first auxiliary flow path which allows fluid flow only in soft mode during the compression and extension strokes and is closed in hard mode, and a second auxiliary flow path which allows fluid flow for compression pressure adjustment only in the hard mode during the compression stroke are formed. The damping force adjusting unit includes a check valve unit that selectively opens the second auxiliary flow path.

### CROSS-REFERENCE TO RELATED APPLICATIONS

This application claims benefit and priority to Korean Patent Application No. 10-2023-0159043, filed on Nov. 16, 2023, with the Korean Intellectual Property Office, the disclosure of which is incorporated herein in its entirety by reference.

### TECHNICAL FIELD

The present disclosure relates to a damping force variable valve assembly and a shock absorber including the same, and more particularly, to a damping force variable valve assembly that is provided in a cylinder to change damping force during compression and extension strokes, and a shock absorber including the same.

### BACKGROUND

A shock absorber is installed in a vehicle such as a car to improve riding comfort by absorbing and cushioning vibrations and shocks received from the road surface while the vehicle drives. The shock absorber includes a cylinder and a piston rod that is compressed and extendible in the cylinder.

Among shock absorbers, a shock absorber with a low damping force can improve riding comfort by absorbing vibrations caused by unevenness of the road surface when driving, while a shock absorber with a high damping force can improve steering stability by suppressing changes in the posture of a vehicle body.

Recently, variable damping shock absorbers have been applied to vehicles, where the characteristics of the damping force can be set differently depending on the intended use of the vehicle. Generally, the variable damping force shock absorber includes an outer tube, an inner tube, installed in the outer tube, in which a piston rod is movably installed in a longitudinal direction, a piston valve that is coupled to one end of the piston rod and divides the inner tube into a compression chamber and an extension chamber, and a damping force variable valve assembly for adjusting the damping force.

The damping force variable valve assembly can be categorized as an internal type provided inside the cylinder and an external type provided outside the cylinder. In the case of the internal type, the damping force variable valve assembly may be provided integrally with the piston valve.

The internal type damping force variable valve assembly has a main flow path and an auxiliary flow path that allow the compression chamber and the extension chamber in the cylinder to communicate with each other. During compression and extension strokes, most of the fluid movement between the compression chamber and the extension chamber occurs through the main flow path, and when variable damping force is required, the auxiliary flow path is used.

When the auxiliary flow path is opened, low damping force is generated because the fluid moves through the auxiliary flow path in addition to the main flow path during compression and extension strokes, which is called soft mode. When the auxiliary flow path is closed, high damping force is generated because the fluid moves only through the main flow path during the compression and extension strokes, which is called hard mode.

According to the conventional internal type damping force variable valve assembly, the compression stroke pressure changes rapidly when the flow rate increases, which may cause rebound lag phenomenon in hard mode (particularly at high speed) due to insufficient fluid flow to the extension chamber during the compression stroke. In addition, the rigidity of the valve body needs to be increased to improve the rebound lag phenomenon, which may reduce a tuning range of the valve.

### SUMMARY

In view of the above, the present disclosure provides a damping force variable valve assembly and shock absorber capable of preventing rapid changes in compression stroke pressure when a flow rate increases.

A damping force variable valve assembly, in accordance with a preferred embodiment of the present disclosure, comprises: a piston valve for dividing an internal space of a fluid-filled cylinder into a compression chamber and an extension chamber; an outer housing having an upper end to which a piston rod is coupled and a lower end to which the piston valve is coupled, and moving reciprocally in the cylinder; a solenoid disposed in the outer housing; and a damping force adjustment unit provided between the solenoid and the piston valve in the outer housing and actuated by the solenoid to adjust a damping force.

In the outer housing and the damping force adjustment unit, a main flow path through which fluid flows during compression and extension strokes, a first auxiliary flow path which allows fluid flow only in soft mode during the compression and extension strokes and is closed in hard mode, and a second auxiliary flow path which allows fluid flow for compression pressure adjustment only in the hard mode during the compression stroke are formed.

The damping force adjusting unit includes a check valve unit that selectively opens the second auxiliary flow path.

A pilot chamber through which fluid passes in the soft mode is formed in the damping force adjustment unit, an inlet side of the second auxiliary flow path is connected to the first auxiliary flow path and an outlet side of the second auxiliary flow path is connected to the pilot chamber, and the check valve unit is provided on the inlet side of the second auxiliary flow path.

The damping force adjusting unit includes: an inner housing which is disposed in the outer housing, has a hollow in a longitudinal direction, and has a seating portion formed around one end opening located on the solenoid side, wherein a first vertical pilot passage is formed in the seating portion; a main poppet movably disposed in the inner housing to open/close the main flow path, wherein the pilot chamber is formed between the main poppet and the inner housing, and a poppet chamber is formed between the main poppet and the solenoid; a pilot poppet which is moved up and down by operation of the solenoid to open/close the first auxiliary flow path; and the check valve unit which is seated on the seating portion and opens/closes the first vertical pilot passage.

The second auxiliary flow path includes the first vertical pilot passage.

The main flow path includes: an outer through-hole formed in a periphery of the outer housing and communicating with the extension chamber, and a first inner through-hole formed in a periphery of the inner housing and communicating with the compression chamber.

A second inner through-hole is formed in a periphery of the inner housing to allow the pilot chamber and a space between the outer housing and the inner housing to communicate with each other.

Passages formed in the main poppet includes: a second vertical pilot passage formed in the form of an upwardly open groove in the main poppet and having an upper opening opened/closed by the pilot poppet; a horizontal pilot passage formed horizontally in the main poppet to allow the second vertical pilot passage and the pilot chamber to communicate with each other; and a third vertical pilot passage formed vertically in the main poppet to allow upper and lower spaces of the main poppet to communicate with each other.

A poppet insertion portion into which the pilot poppet is inserted is formed at an upper end of the second vertical pilot passage.

The seating portion includes a horizontal seating surface on which the check valve unit is seated and in which the first vertical pilot passage is formed.

The check valve unit includes: an upper cover formed in a ring shape and seated on the seating surface, and including a horizontal surface in which a vertical fluid through-hole is formed and a peripheral portion formed perpendicular to an edge of the horizontal surface; at least one disk seated on the horizontal surface to bring the upper cover into close contact with the seating surface; and a check valve provided in a groove formed at the inlet side of the second auxiliary flow path between the upper cover and the seating portion.

The at least one disk includes: a first disk formed in a ring shape, seated on an upper surface of the horizontal surface, and having a slit communicating with the fluid through-hole; a second disk formed in a ring shape, seated on an upper surface of the first disk, and having an opening communicating with the slit and opening to the poppet chamber; and a third disk formed in a ring shape and seated on an upper surface of the second disk to cover an upper portion of the opening.

The slit is formed in an arc shape and includes one or more slits.

The first auxiliary flow path includes the poppet chamber.

The inlet side of the second auxiliary flow path is connected to the poppet chamber, and the outlet side is connected to the pilot chamber.

A combined thickness of the first disk, the second disk, and third disk is equal to a height of the peripheral portion.

An opening amount of the check valve is adjusted by fluid pressure.

A damping force variable shock absorber, in accordance with a preferred embodiment of the present disclosure, includes a damping force variable valve assembly provided in a cylinder to adjust a damping force during compression and extension strokes.

In the damping force variable valve assembly, a main flow path through which fluid flows during compression and extension strokes, a first auxiliary flow path which allows fluid flow only in soft mode during the compression and extension strokes and is closed in hard mode, and a second auxiliary flow path which allows fluid flow for compression pressure adjustment only in the hard mode during the compression stroke are formed.

The damping force variable valve assembly is provided with a check valve unit that selectively opens/closes the second auxiliary flow path.

A pilot chamber through which fluid passes in the soft mode is formed in the damping force variable valve assembly, an inlet side of the second auxiliary flow path is connected to the first auxiliary flow path and an outlet side of the second auxiliary flow path is connected to the pilot chamber, and the check valve unit is provided on the inlet side of the second auxiliary flow path.

According to the damping force variable valve assembly and shock absorber of the present disclosure, by forming the main flow path through which fluid flows essentially between the compression chamber and the extension chamber during compression and extension strokes, the first auxiliary flow path through which fluid flows only in soft mode, and the second auxiliary flow path through which fluid flows only in hard mode, the damping force of the shock absorber can be adjusted. In the case of the second auxiliary flow path, the rebound lag phenomenon can be prevented by preventing a large pressure change during the compression stroke in the hard mode.

In addition, according to the damping force variable valve assembly and shock absorber of the present disclosure, by improving the adhesion between the check valve unit and the seating portion, it is possible to prevent the soft mode pressure from unintentionally increasing during the compression stroke. That is, it is possible to prevent a large amount of fluid from unintentionally flowing into the pilot chamber during the compression stroke in soft mode.

### BRIEF DESCRIPTION OF THE DRAWINGS

FIG. 1 is a cross-sectional view showing a damping force variable valve assembly according to a first embodiment of the present disclosure.

FIG. 2 is an enlarged view of a damping force adjustment unit shown in FIG. 1.

FIG. 3 is a diagram showing fluid flowing along a main flow path of the damping force variable valve assembly according to the first embodiment of the present disclosure.

FIGS. 4 and 5 are diagrams showing fluid flowing along a first auxiliary flow path of the damping force variable valve assembly according to the first embodiment of the present disclosure.

FIG. 6 is a diagram showing fluid flowing along the main flow path and a second auxiliary flow path of the damping force variable valve assembly according to the first embodiment of the present disclosure.

FIG. 7 is a cross-sectional perspective view showing the relationship between an inner housing, a main poppet, and a check valve unit.

FIG. 8 is a graph showing the change in pressure versus flow rate when adjusting the compression stroke pressure during the compression stroke of a shock absorber to which the damping force valve assembly according to the first embodiment of the present disclosure is applied.

FIG. 9 is a cross-sectional view showing a damping force variable valve assembly according to a second embodiment of the present disclosure.

FIG. 10 is a cross-sectional perspective view showing fluid flowing through a check valve unit and a second auxiliary flow path of FIG. 9.

FIG. 11 is an exploded perspective view of the check valve unit shown in FIG. 10.

FIG. 12 is a top view of a top cover.

FIG. 13 is a top view of a first disk.

FIG. 14 is a top view of a second disk.

FIG. 15 is a top view of a third disk.

FIG. 16 is a graph showing the pressure change when the damping force is adjusted to soft mode during the compression stroke of the shock absorber to which the damping force valve assemblies according to the first and second embodiments of the present disclosure are applied, respectively.

### DETAILED DESCRIPTION

Hereinafter, a damping force variable valve assembly and a shock absorber according to preferred embodiments of the present disclosure will be described in detail with reference to the accompanying drawings.

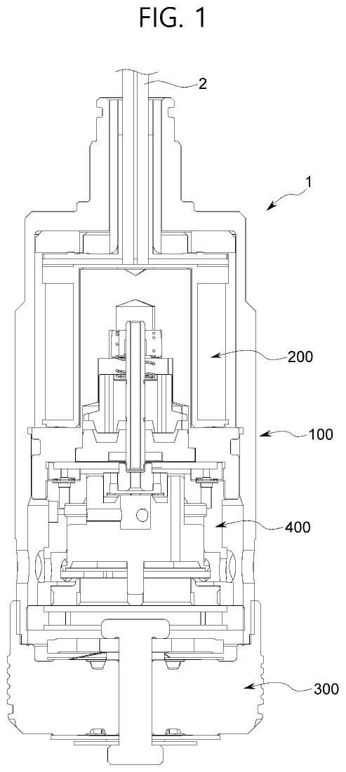

FIG. 1 is a cross-sectional view showing a damping force variable valve assembly according to a first embodiment of the present disclosure.

The damping force variable valve assembly 1 according to the first embodiment of the present disclosure is provided in a cylinder (not shown) and slides in the cylinder during compression and extension strokes to adjust the damping force of the shock absorber.

A variable damping force shock absorber according to the first embodiment of the present disclosure includes a cylinder (not shown) with a double tube structure of an inner tube and an outer tube, a piston rod 2 penetrating one end of the cylinder, and a body valve (not shown) mounted on the other end of the cylinder, and the damping force variable valve assembly 1 provided in the cylinder to adjust the damping force. The internal space of the cylinder is divided into a compression chamber (not shown) and an extension chamber (not shown) by the damping force variable valve assembly 1.

The damping force variable valve assembly 1 includes an outer housing 100 with a space formed therein and an open bottom, a solenoid 200 disposed at an upper inner side in the outer housing 100, a piston valve 300 coupled to a lower end of the outer housing 100, and a damping force adjustment unit 400 provided between the solenoid 200 and the piston valve 300 in the outer housing 100 and actuated by the operation of the solenoid 200 to adjust the damping force. The piston rod 2 is coupled to an upper end of the outer housing 100.

As will be described later, three fluid flow paths are formed in the damping force variable valve assembly 1. A main flow path through which fluid flows essentially between the compression chamber and the extension chamber during compression and extension strokes and a large amount of fluid flows, a first auxiliary flow path through which fluid flows only in soft mode, and a second auxiliary flow path through which fluid flows only in hard mode are formed in the damping force variable valve assembly 1, so that the damping force of the shock absorber can be adjusted. In this case, in the case of the second auxiliary flow path, the rebound lag phenomenon can be prevented by preventing a large pressure change during the compression stroke in the hard mode.

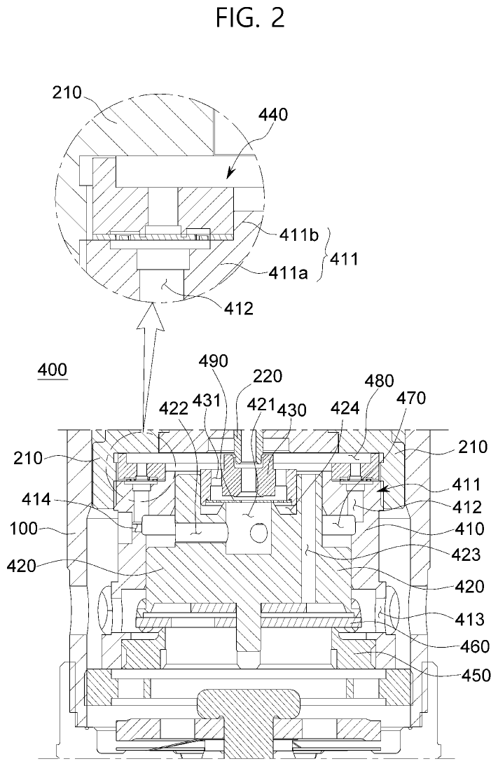

FIG. 2 is an enlarged view of the damping force adjustment unit shown in FIG. 1.

A plunger 210 is provided at a lower portion of the solenoid 200, and a spool 220, which is moved up and down by the operation of the solenoid 200, passes through the center of the plunger 210. At a lower portion of the plunger 210, an insertion part into which an upper part of an inner housing 410 and a check valve unit 440, which will be described later, are inserted, is formed to open downward.

The damping force adjusting unit 400 includes an inner housing 410, a main poppet 420, a pilot poppet 430, a check valve unit 440, a main seat 450, and a ring disk 460.

The inner housing 410 is disposed in an inner lower portion of the outer housing 100, has a hollow extending in a longitudinal direction (up-down direction), and has a seating portion 411 formed around one end (top) opening located on the solenoid side. A first vertical pilot passage 412 is formed in the seating portion 411. The first vertical pilot passage 412 constitutes a second auxiliary passage. A first inner through-hole 413 communicating with the compression chamber is formed at a lower peripheral portion of the inner housing 410, and a second inner through-hole 414, which allows a space between the outer housing 100 and the inner housing 410 and the pilot chamber 470 to be described later to communicate with each other, is formed at an upper peripheral portion of the inner housing 410.

The seating portion 411 includes a horizontal seating surface 411a on which the check valve unit 440 is seated and the first vertical pilot passage 412 is formed, and a fitting protrusion 411b, protruding upward from an inner side of the seating surface 411a, into which the annular check valve unit 440 is fitted.

The main poppet 420 is movably disposed in the inner housing to open/close the main flow path, wherein a pilot chamber 470 is formed between the main poppet 420 and the inner housing 410, and a poppet chamber 480 is formed between the main poppet 420 and the solenoid 200. A second vertical pilot passage 421, a horizontal pilot passage 422, and a third vertical pilot passage 423 are formed in the main poppet 420. The second vertical pilot passage 421 is formed in the form of an upwardly open groove at an upper portion of the main poppet 420, and the upper opening is opened and closed by the pilot poppet 430. The horizontal pilot passage 422 is formed horizontally at a side portion of the main poppet 420 to allow the second vertical pilot passage 421 and the pilot chamber 470 to communicate with each other. The third vertical pilot passage 423 is formed vertically in the main poppet 420 to allow the spaces above and below the main poppet 420 to communicate with each other.

The pilot poppet 430 is inserted into a poppet insertion portion 424 formed at an upper end of the second vertical pilot passage 421 and is moved up and down by the operation of the solenoid 200 to open or close the second vertical pilot passage 421. An elastic disk 490 is provided below the pilot poppet 430 to elastically support the pilot poppet 430 in the poppet insertion portion 424. A fourth vertical pilot passage 431 through which fluid flows vertically is formed in the pilot poppet 430.

The check valve unit 440 is seated on the seating portion 411 of the inner housing 410 within the poppet chamber 480 and opens/closes the first vertical pilot passage 412. The poppet chamber 480 is a space between the solenoid 200 and the inner housing 410, specifically between the plunger 210 and the inner housing 410. The upper inlet side of the first vertical pilot passage 412 is connected to the poppet chamber 480, and the lower outlet side is connected to the pilot chamber 470. The upper inlet side of the first vertical pilot passage 412 is located at the edge of the poppet chamber 480.

The main seat 450 is fixed to the inner bottom of the inner housing 410 to prevent the main poppet 420 from being separated. The main seat 450 has a penetrating portion formed at the center through which fluid communicates during compression and extension strokes.

The ring disk 460 is provided between the main poppet 420 and the main seat 450, and has a donut-shaped hole at the center through which fluid passes.

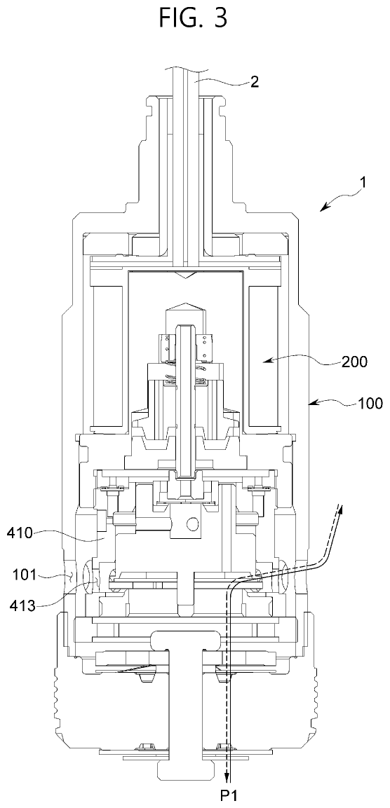

FIG. 3 is a diagram showing fluid flowing along the main flow path of the damping force variable valve assembly according to the first embodiment of the present disclosure.

During the compression stroke, the fluid in the compression chamber is transferred to the extension chamber through the main flow path P1, and during the extension stroke, the fluid in the extension chamber is transferred to the compression chamber through the main flow path P1.

The main flow path P1 is a route passing through the passage formed in the piston valve 300, the through-hole of the main seat 450, the first inner through-hole 413 of the inner housing 410, and an outer through-hole 101 of the outer housing 100 in that order.

During the compression stroke, the fluid in the compression chamber passes through the above passages in order and then is transferred to the extension chamber (solid arrow in FIG. 3), and during the extension stroke, the fluid in the extension chamber passes through each passage in the reverse order to that during the compression stroke and then is transferred to the compression chamber (dotted arrow in FIG. 3).

The main flow path P1 always remains open during the compression and extension strokes, regardless of soft mode or hard mode, and a large amount of fluid passes through it.

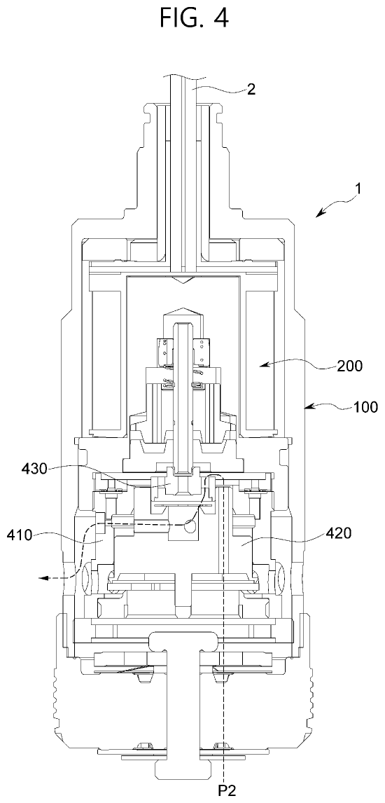

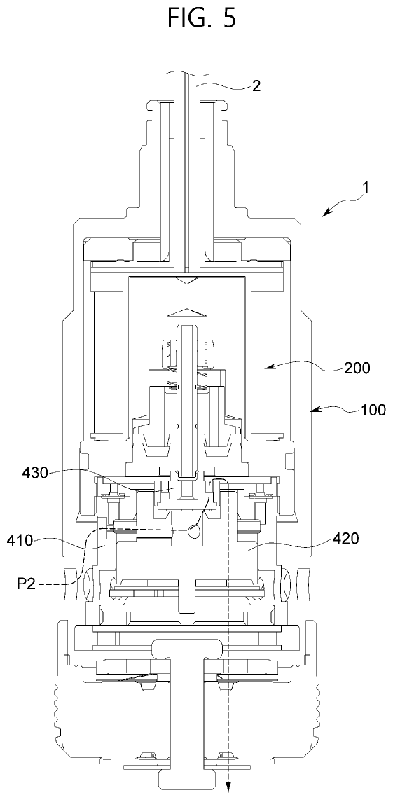

FIGS. 4 and 5 are diagrams showing fluid flowing along the first auxiliary flow path of the damping force variable valve assembly according to the first embodiment of the present disclosure.

As described above, the damping force characteristics may be set to soft mode and hard mode depending on the purpose of use of the vehicle. FIGS. 4 and 5 show fluid flowing in the soft mode.

When the damping force characteristics are set to soft mode, the shock absorber can improve ride comfort by absorbing vibrations caused by unevenness in the road surface.

In the soft mode, the fluid flows additionally through the first auxiliary flow path P2 in addition to the main flow path P1, thereby generating low damping force during compression and extension strokes.

The first auxiliary flow path P2 is a route passing through the passage formed in the piston valve 300, the through-hole of the main seat 450, the third vertical pilot passage 423 of the main poppet 420, the poppet chamber 480, the fourth vertical pilot passage 431 of the pilot poppet 430, the second vertical pilot passage 421 of the main poppet 420, the horizontal pilot passage 422 of the main poppet 420, the pilot chamber 470, the second inner through-hole 414 of the inner housing, and the outer through-hole 101 of the outer housing in that order.

In the soft mode, the pilot poppet 430 is moved up by the operation of the solenoid 200 to open the second vertical pilot passage 421.

During the compression stroke, the fluid in the compression chamber passes through the above passages in order and then is transferred to the extension chamber (dotted arrow in FIG. 4), and during the extension stroke, the fluid in the extension chamber passes through each passage in the reverse order to that during the compression stroke and then is transferred to the compression chamber (dotted arrow in FIG. 5).

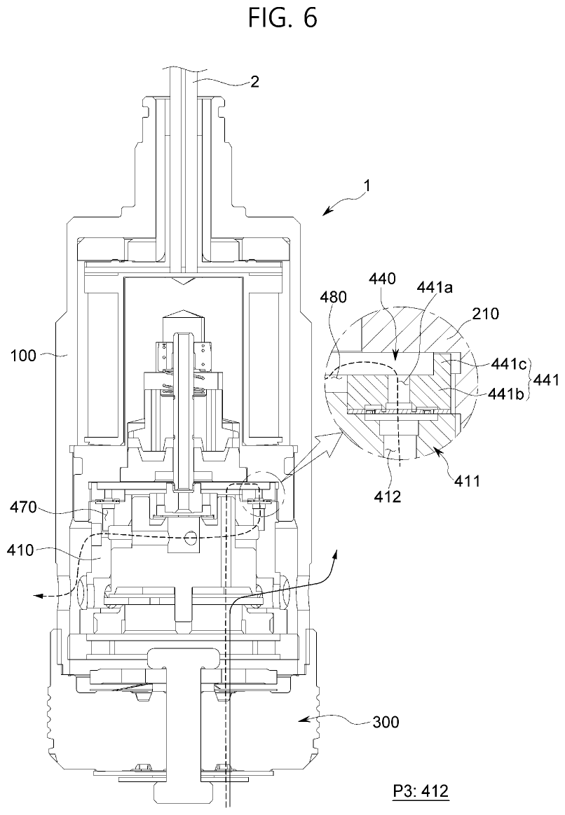

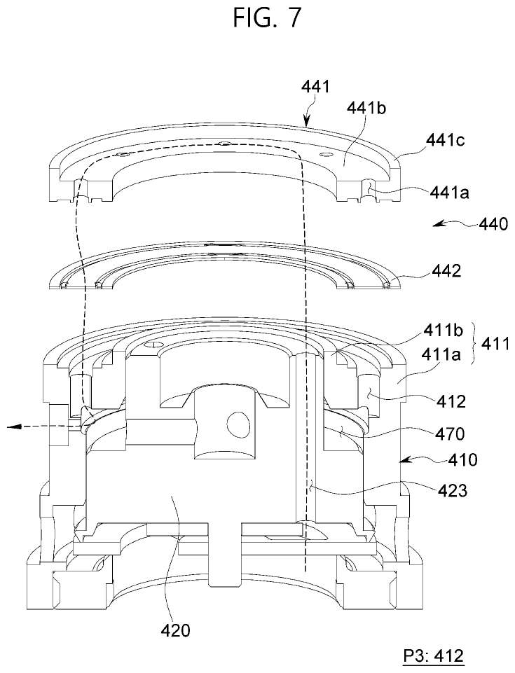

FIG. 6 is a diagram showing fluid flowing along the main flow path and the second auxiliary flow path of the damping force variable valve assembly according to the first embodiment of the present disclosure, and FIG. 7 is a cross-sectional perspective view showing the relationship between the inner housing, the main poppet, and the check valve unit.

As described above, when the fluid moves using only the main flow path P1 during the compression stroke, the compression stroke pressure has the characteristic of rapidly changing when the compression flow rate increases, which may cause rebound lag phenomenon in hard mode (particularly at high speed) due to insufficient fluid flow to the extension chamber during the compression stroke.

Accordingly, in the present disclosure, the fluid moves through the second auxiliary flow path P3 in addition to the main flow path P1 during the compression stroke, thereby improving the characteristic of the compression stroke pressure changing rapidly.

The second auxiliary flow path P3 includes the first vertical pilot passage 412. As described above, the upper inlet side of the first vertical pilot passage 412 is connected to the poppet chamber 480, and the lower outlet side thereof is connected to the pilot chamber 470.

During the compression stroke, the fluid flow path other than the main flow path P1 includes the passage formed in the piston valve 300, the passage in the main seat 450, the third vertical pilot passage 423 of the main poppet 420, the poppet chamber 480, the check valve unit 440, the second auxiliary flow path P3, the pilot chamber 470, the second inner through-hole 414 of the inner housing 410, and the outer through-hole 101 of the outer housing 100.

The check valve unit 440 is seated on the seating portion 411 of the inner housing 410 to selectively open/close the first vertical pilot passage 412, and allows the fluid flow from the poppet chamber 480 to the pilot chamber 470 and blocks the opposite flow. That is, the check valve unit 440 is open during the compression stroke and closed during the extension stroke. The check valve unit 440 includes an upper cover 441 and a check valve 442.

The upper cover 441 is formed in a ring shape and is seated on the seating surface 411a while being fitted in the fitting protrusion 411b of the seating portion 411, and includes a horizontal surface 441b in which a vertical fluid through-hole 441a is formed and a peripheral portion 441c formed perpendicular to an edge of the horizontal surface 441b. A space is formed inside the peripheral portion 441c. A plurality of fluid through-holes 441a are formed on a concentric circle in the horizontal surface 441b and spaced apart at equal intervals.

The check valve 442 is inserted into the insertion groove formed on the inlet side of the first vertical pilot passage 412 on the seating surface 411a to allow the fluid flow from the fluid through-hole 441a to the first vertical pilot passage 412 and block the fluid flow in the opposite direction. A slit (not shown) through which fluid passes is formed in the check valve 442. The opening amount of the check valve 442 may be adjusted in proportion to the fluid pressure.

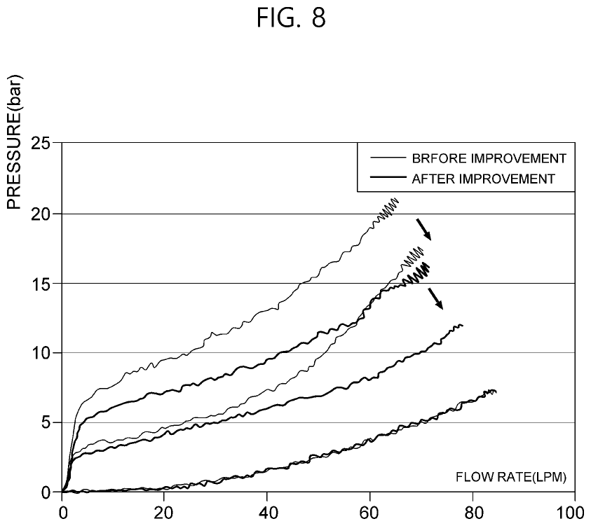

FIG. 8 is a graph showing the change in pressure versus flow rate when adjusting the compression stroke pressure during the compression stroke of the shock absorber to which the damping force valve assembly according to the first embodiment of the present disclosure is applied.

It can be seen that when the damping force variable valve assembly 1 according to the first embodiment of the present disclosure is applied, the compression stroke pressure change is gentle compared to the conventional shock absorber even though the flow rate increases as the compression stroke progresses.

This improvement in the compression stroke pressure change can prevent the occurrence of rebound lag phenomenon in the hard mode, especially at high speeds, because sufficient fluid flows into the extension chamber during the compression stroke.

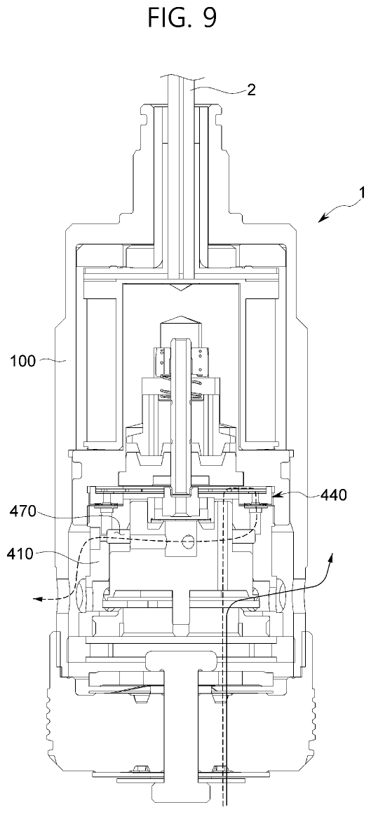

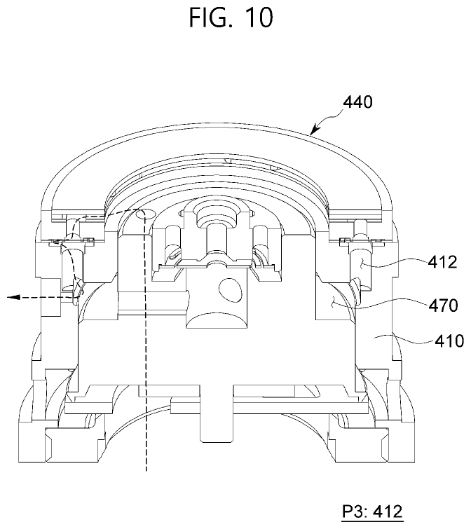

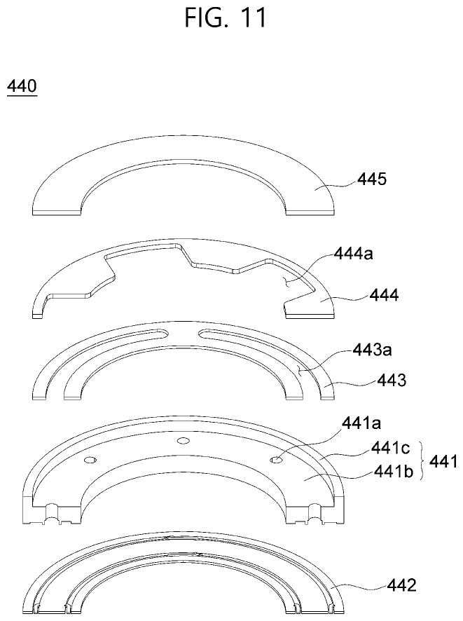

FIG. 9 is a cross-sectional view showing a damping force variable valve assembly according to a second embodiment of the present disclosure, FIG. 10 is a cross-sectional perspective view showing fluid flowing through a check valve unit and a second auxiliary flow path of FIG. 9, and FIG. 11 is an exploded perspective view of the check valve unit shown in FIG. 10.

In the damping force variable valve assembly according to the first embodiment of the present disclosure, when the damping force is adjusted to the soft mode during the compression stroke, fluid flows through the first auxiliary flow path P2 via the poppet chamber 480.

As described above, the check valve unit 440 is provided in the edge space of the poppet chamber 480. Therefore, when the damping force is adjusted to the soft mode during the compression stroke, if the check valve unit 440 is not in close contact with the seating portion 411 of the inner housing 410, the fluid in the poppet chamber 480 may leak into the first vertical pilot passage 412 through a minute gap between the check valve unit 440 and the seating portion 411 and unintentionally flow into the pilot chamber 470.

When the damping force is adjusted to the soft mode during the compression stroke, the fluid in the compression chamber should normally flow into the pilot chamber 470 only through the poppet chamber 480, the fourth vertical pilot passage 431 of the pilot poppet 430, and the second vertical pilot passage 421 and the horizontal pilot passage 422 of the main poppet 420, but if fluid flows abnormally into the pilot chamber 470 even through the first vertical pilot passage 412 as described above, the fluid flow into the pilot chamber 470 becomes excessive.

As such, excessive fluid flow into the pilot chamber 470 when the damping force is adjusted to the soft mode during the compression stroke causes the soft mode pressure to increase during the compression stroke. This may cause excessive damping force at low speeds in the soft mode, causing a decrease in ride comfort.

Accordingly, in the damping force variable valve assembly according to the second embodiment of the present disclosure, by improving the adhesion between the check valve unit 440 and the seating portion 411 it is possible to prevent the soft mode pressure from unintentionally increasing during the compression stroke.

To this end, in the check valve unit 440 of the damping force variable valve assembly according to the second embodiment of the present disclosure, first, second, and third disks 443, 444, and 445 are stacked in that order on the upper surface of the upper cover 441, so that a load is applied to the upper cover 441 to make the upper cover 441 come into close contact with the seating portion 411 of the inner housing 410. The combined thickness of the first, second, and third disks 443, 444, and 445 is equal to the height of the peripheral portion 441c.

The first disk 443 is formed in a ring shape and is seated on the horizontal surface 441b of the upper cover 441, and the second disk 444 is formed in a ring shape and is seated on an upper surface of the first disk 443, and the third disk 445 is formed in a ring shape and is seated on an upper surface of the second disk 444. In this case, passages are formed in the first and second disks 443 and 444 that allow fluid in the poppet chamber 480 to flows through the upper cover 441 and into the first vertical pilot passage 412.

The upper cover 441 and the check valve 442 of the check valve unit 440 constituting the damping force variable valve assembly 1 according to the second embodiment of the present disclosure are the same as those in the first embodiment, so detailed description thereof will be omitted.

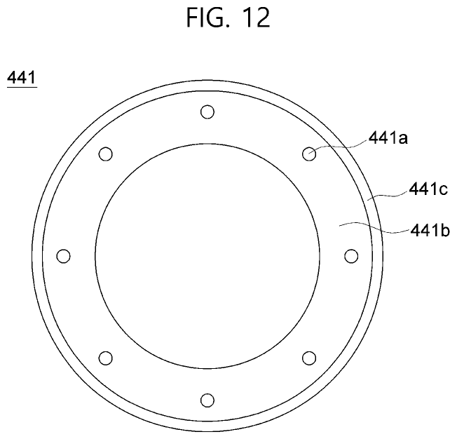

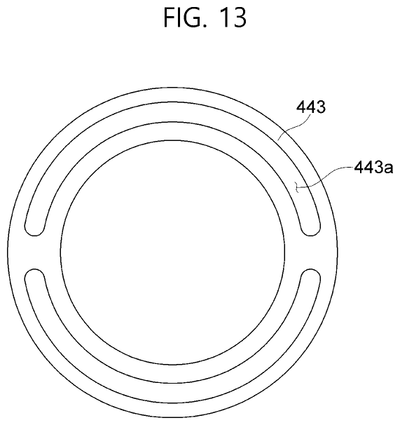

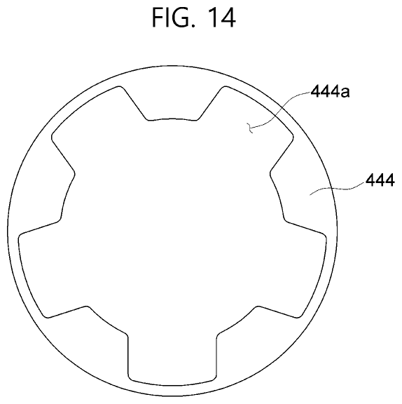

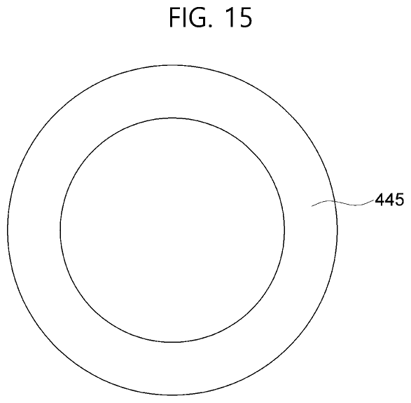

FIG. 12 is a top view of the upper cover, FIG. 13 is a top view of the first disk, FIG. 14 is a top view of the second disk, and FIG. 15 is a top view of the third disk.

The upper cover 441 includes a horizontal surface 441b in which a vertical fluid through-hole 441a is formed, and a peripheral portion 441c formed perpendicular to an edge of the horizontal surface 441b. A space is formed inside the peripheral portion 441c. A plurality of fluid through-holes 441a are formed on a concentric circle in the horizontal surface 441b and spaced apart at equal intervals.

The first disk 443 is seated on the horizontal surface 441b of the upper cover 441, and two arc-shaped slits 443a are formed in the first disk 443. The slits 443a communicate with the fluid through-holes 441a formed in the upper cover 441. Although two slits 443a are formed in the drawings, the present disclosure is not limited thereto and one or more slits may be applied as long as they communicate with all fluid through-holes 441a.

The second disk 444 is formed with a plurality of openings 444a communicating with the slits 443a of the first disk 443. The openings 444a open to the poppet chamber 480.

The third disk 445 is seated on the upper surface of the second disk 444 to cover the openings 444a.

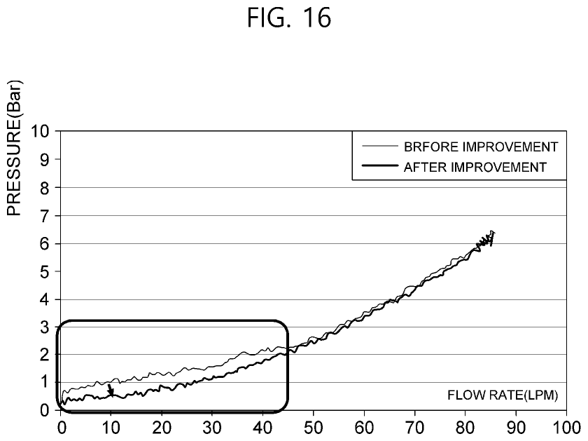

FIG. 16 is a graph showing the pressure change when the damping force is adjusted to the soft mode during the compression stroke of the shock absorber to which the damping force valve assemblies according to the first and second embodiments of the present disclosure are applied, respectively.

It can be seen that when the disks 443, 444, 445 are stacked on the upper cover 441 (after improvement) as in the second embodiment compared to when only the upper cover 441 is provided on the check valve 442 (before improvement) as in the first embodiment of the present disclosure, the soft pressure at the beginning of soft mode (at low speed in soft mode) is lowered. That is, the soft pressure can be improved to a normal state.

This improvement of the soft pressure to a normal state can allow the intended normal vehicle ride comfort in the soft mode.

While the damping force variable valve assembly and shock absorber according to the preferred embodiments of the present disclosure have been described in detail with reference to the accompanying drawings as described above, the present disclosure is not limited to the above-described embodiments and may be implemented in various modifications within the scope of the following claims.

What is claimed is:

1. A damping force variable valve assembly comprising:
a piston valve for dividing an internal space of a fluid-filled cylinder into a compression chamber and an extension chamber;
an outer housing having an upper end to which a piston rod is coupled and a lower end to which the piston valve is coupled, and moving reciprocally in the cylinder;
a solenoid disposed in the outer housing; and
a damping force adjustment unit provided between the solenoid and the piston valve in the outer housing and actuated by the solenoid to adjust a damping force,
wherein in the outer housing and the damping force adjustment unit, a main flow path through which fluid flows during compression and extension strokes, a first auxiliary flow path which allows fluid flow only in soft mode during the compression and extension strokes and is closed in hard mode, and a second auxiliary flow path which allows fluid flow for compression pressure adjustment only in the hard mode during the compression stroke are formed, and
the damping force adjusting unit includes a check valve unit that selectively opens the second auxiliary flow path.

2. The damping force variable valve assembly of claim 1, wherein a pilot chamber through which fluid passes in the soft mode is formed in the damping force adjustment unit, an inlet side of the second auxiliary flow path is connected to the first auxiliary flow path and an outlet side of the second auxiliary flow path is connected to the pilot chamber, and the check valve unit is provided on the inlet side of the second auxiliary flow path.

3. The damping force variable valve assembly of claim 2, wherein the damping force adjusting unit includes:
an inner housing which is disposed in the outer housing, has a hollow in a longitudinal direction, and has a seating portion formed around one end opening located on the solenoid side, wherein a first vertical pilot passage is formed in the seating portion;
a main poppet movably disposed in the inner housing to open/close the main flow path, wherein the pilot chamber is formed between the main poppet and the inner housing, and a poppet chamber is formed between the main poppet and the solenoid;
a pilot poppet which is moved up and down by operation of the solenoid to open/close the first auxiliary flow path; and
the check valve unit which is seated on the seating portion and opens/closes the first vertical pilot passage.

4. The damping force variable valve assembly of claim 3, wherein the second auxiliary flow path includes the first vertical pilot passage.

5. The damping force variable valve assembly of claim 3, wherein the main flow path includes:
an outer through-hole formed in a periphery of the outer housing and communicating with the extension chamber, and
a first inner through-hole formed in a periphery of the inner housing and communicating with the compression chamber.

6. The damping force variable valve assembly of claim 3, wherein a second inner through-hole is formed in a periphery of the inner housing to allow the pilot chamber and a space between the outer housing and the inner housing to communicate with each other.

7. The damping force variable valve assembly of claim 6, wherein passages formed in the main poppet includes:
a second vertical pilot passage formed in the form of an upwardly open groove in the main poppet and having an upper opening opened/closed by the pilot poppet;
a horizontal pilot passage formed horizontally in the main poppet to allow the second vertical pilot passage and the pilot chamber to communicate with each other; and
a third vertical pilot passage formed vertically in the main poppet to allow upper and lower spaces of the main poppet to communicate with each other.

8. The damping force variable valve assembly of claim 7, wherein a poppet insertion portion into which the pilot poppet is inserted is formed at an upper end of the second vertical pilot passage.

9. The damping force variable valve assembly of claim 4, wherein the seating portion includes a horizontal seating surface on which the check valve unit is seated and in which the first vertical pilot passage is formed.

10. The damping force variable valve assembly of claim 9, wherein the check valve unit includes:
an upper cover formed in a ring shape and seated on the seating surface, and including a horizontal surface in which a vertical fluid through-hole is formed and a peripheral portion formed perpendicular to an edge of the horizontal surface;
at least one disk seated on the horizontal surface to bring the upper cover into close contact with the seating surface; and
a check valve provided on the inlet side of the second auxiliary flow path between the upper cover and the seating portion.

11. The damping force variable valve assembly of claim 10, wherein the at least one disk includes:
a first disk formed in a ring shape, seated on an upper surface of the horizontal surface, and having a slit communicating with the fluid through-hole;
a second disk formed in a ring shape, seated on an upper surface of the first disk, and having an opening communicating with the slit and opening to the poppet chamber; and
a third disk formed in a ring shape and seated on an upper surface of the second disk to cover an upper portion of the opening.

12. The damping force variable valve assembly of claim 11, wherein the slit is formed in an arc shape and includes one or more slits.

13. The damping force variable valve assembly of claim 4, wherein the first auxiliary flow path includes the poppet chamber.

14. The damping force variable valve assembly of claim 13, wherein the inlet side of the second auxiliary flow path is connected to the poppet chamber, and the outlet side is connected to the pilot chamber.

15. The damping force variable valve assembly of claim 11, wherein a combined thickness of the first disk, the second disk, and third disk is equal to a height of the peripheral portion.

16. The damping force variable valve assembly of claim 10, wherein an opening amount of the check valve is adjusted by fluid pressure.

17. A damping force variable shock absorber, which includes a damping force variable valve assembly provided in a cylinder to adjust a damping force during compression and extension strokes, wherein:
in the damping force variable valve assembly, a main flow path through which fluid flows during compression and extension strokes, a first auxiliary flow path which allows fluid flow only in soft mode during the compression and extension strokes and is closed in hard mode, and a second auxiliary flow path which allows fluid flow for compression pressure adjustment only in the hard mode during the compression stroke are formed, and
the damping force variable valve assembly is provided with a check valve unit that selectively opens/closes the second auxiliary flow path.

18. The damping force variable shock absorber of claim 17, wherein a pilot chamber through which fluid passes in the soft mode is formed in the damping force variable valve assembly, an inlet side of the second auxiliary flow path is connected to the first auxiliary flow path and an outlet side of the second auxiliary flow path is connected to the pilot chamber, and the check valve unit is provided on the inlet side of the second auxiliary flow path.

19. The damping force variable shock absorber of claim 18, wherein the check valve unit includes:
an upper cover formed in a ring shape and seated on a seating portion formed on the inlet side of the second auxiliary flow path;
at least one disk that is seated on the upper cover to bring the upper cover into close contact with the seating portion; and
a check valve provided on the inlet side of the second auxiliary passage between the upper cover and the seating portion.

20. The damping force variable shock absorber of claim 19, wherein an opening amount of the check valve is adjusted by fluid pressure.
